(19) United States
(12) Patent Application Publication
(10) Pub. No.: US 2009/0204442 A1
(43) Pub. Date: Aug. 13, 2009

(54) METHOD OF VALUATION OF LIFE SETTLEMENTS AND OPTIMIZING PREMIUM FINANCING

(76) Inventors: Leslie W. Logsdon, Naples, FL (US); Ian Sidney Cotton, Wichita Falls, TX (US); Andrew J. Walter, Arnold, MD (US); R. Laken Mitchell, Naples, FL (US)

Correspondence Address: BROOKE SCHUMM III;Daneker, McIntire, Schumm, Prince, Goldstein et al, ONE NORTH CHARLES STREET, SUITE 2450, BALTIMORE, MD, 21201, US

(21) Appl. No.: 12/162,909

(22) PCT Filed: Jan. 30, 2007
(86) PCT No.: PCT/US07/61268

§ 371 Date: Mar. 23, 2009

Related U.S. Application Data
(60) Provisional application No. 60/766,642, filed on Feb. 2, 2006.
(60) Provisional application No. 60/877,082, filed on Dec. 26, 2006.

(51) Int. Cl. G06Q 40/00

(52) U.S. Cl. 705/4

(57) ABSTRACT

The present invention proposes to integrate mortality table analysis and the future premium burden thereby creating a unit net asset value (“Unit NAV”) for investors holding a unit in the fund. A major component of Unit NAV in a viatical and life settlement transaction is the amount of expected premium burden yet to be paid during the anticipated lifetime of the insured. The future premium burden is in essence the “measure of risk” associated with the policy. As time passes, the predictability of paying future premiums is related to the cumulative mortality curve to a point in time. By determining the remaining cumulative mortality curve, the probability of having to pay the future premiums can be determined, and, incorporating these two elements into the valuation model, the anticipated “incremental value” at any point in time can be calculated. A determination can be made as to whether to use internal or external premium financing. Another point of novelty is that the proposed method simultaneously satisfies two different requirements of valuation adopted by the Financial Accounting Standards Board.

### CONTINUATION DATA

This application is a continuation-in-part of U.S. Provisional application 60/766,642 filed on Feb. 2, 2006 having the same name, and a U.S. provisional application 60/887,082 filed 29 Jan. 2007 with the same name.

### FIELD OF INVENTION

This invention relates to a novel method of determining a Unit Net Asset Value (“Unit NAV”) of a fund holding a group of one or more life insurance policies with varying life expectancies, net death benefits, premium burden, and mortality tables. This invention relates to a novel method of analyzing viatical and/or life settlements individually and in a fund or pool of policies by a general purpose computer, which viatical or life settlement transactions involve the sale of a life insurance policy on a person with a life expectancy of less than fifteen years.

### SUMMARY OF INVENTION

The present invention proposes a method to analyze and value a pool of insurance policies including those acquired in viatical and life settlement transactions which are held as part of a fund of policies, and from that analysis to determine a Net Asset Value per unit for the fund. The background is that the fund, using funds raised from investors, pays a substantial sum for the purchase of at least one insurance policy on the life of an insured from the owner of the policy, who is referred to as the viator. The fund assumes the obligation to pay all future premiums on a policy and manage the policy to maturity. Multiple policies are acquired to form a pool of policies and accumulated into the fund. The fund construction would be similar to a mutual fund with the policies being the underlying asset. The fund could be one policy and the invention is applicable to one policy but a fund of one policy would be atypical. The fund, or an investor forming a pool, or one investor buying a policy, usually also has the ability to fund the premiums from an internal source or finance the premiums through third party funding resources. When premium financing is utilized, the interest carry over a long period of time can negatively impact returns on the policy. This impact can be calculated at the time of purchase of the policy based on the anticipated life expectancy and premium burden. The present invention proposes to integrate mortality table analysis and the future premium burden thereby creating a unit net asset value (“Unit NAV”) for investors holding a unit in the fund. A major component of Unit NAV in a viatical and life settlement transaction is the amount of expected premium burden yet to be paid during the anticipated lifetime of the insured. The future premium burden is in essence the “measure of risk” associated with the policy. As time passes, the predictability of paying future premiums is related to the cumulative mortality curve to a point in time. By determining the remaining cumulative mortality curve, the probability of having to pay the future premiums can be determined, and, incorporating these two elements into the valuation model, the anticipated “incremental value” at any point in time can be calculated. A determination can be made as to whether to use internal or external premium financing. Another point of novelty is that the proposed method simultaneously satisfies two different requirements of valuation currently being promulgated by the Financial Accounting Standards Board.

### Valuation Methodology

In the viatical and life settlement context, there is usually an initial starting point of value which is the policy acquisition cost. This will be referred to as the purchase price for the policy. That policy acquisition cost includes a policy purchase price which represents a traditional measure of fair market value: “the price at which the property would change hands between a willing buyer and a willing seller, neither being under any compulsion to buy or sell and both having reasonable knowledge of the relevant facts.” This is generally used as the starting “basis” for valuation. At least facially, that policy acquisition cost represents the transfer between the willing viator or life settlor, and the investor, fund, or financial institution. More precisely, the typical basis is established as the total cost of the policy, beginning with the gross purchase price for buying the policy augmented by the associated fees for the purchase of the policy, assuming a competitive market environment, the sum of which result in the policy purchase price. The parameters determining the purchase price of the policy are primarily the life expectancy of the individual, the premium burden, any cash surrender value, and the net death benefit. The typical life settlement transaction has a mortality table, which if graphed by elapsed time versus probability of death in a given period enables generation of a mortality curve. The mortality curve is associated with the life expectancy and therefore and necessarily a critical component of pricing by default.

Policies on which life settlements or viatical settlements are made usually involve persons with impaired health conditions, and even more usually health conditions that shorten the standard expected mortality for a person of like age. However, life settlements do occur for persons who are simply old, and the term life settlement in this invention includes life settlements for those without an impaired life expectancy.

A major component of basis for the given point of time of purchase is the future premium burden to keep the policy in force to collect the net death benefit at maturity. As time passes, a major component of valuation for a given point in time continues to be premium burden to keep the policy in force to collect the net death benefit at maturity. As the policy reaches and exceeds life expectancy, this premium burden can greatly affect the “incremental value” of the underlying policy, i.e., the incremental increase in value of a policy over time.

Once the policy acquisition cost, which happens to usually be the basis for tax purposes, is established, the time to expected life expectancy elapses, and ultimately “incremental value” begins to count down towards a practical maximum value of a policy. That practical maximum value of a policy is virtually always less than the net death benefit on the policy. As each month passes, there is an expectation based on the mortality table that there will be a certain number of deaths resulting in maturity of the policy. Under the mortality table, or any distribution used, the cumulative maturities at any given point in time produce a probability of maturity. Upon the purchase of the policy, future premium burden is predetermined by obtaining a premium illustration from the issuing carrier of the policy. Using a combination of the premium illustration and the mortality table results in a probability and amount of future premiums at any given point in time. This also produces an “incremental value curve” that is the policy acquisition cost or basis plus any future premium payments compared to the net death benefit. The cumulative mortality curve also gives us the probability of collecting along this “incremental value curve” at any given point in time.

The valuation methodology utilized in the present invention calculates the probability of receiving the value associated with the difference between the net death benefit compared to the probability of obligation to pay future premiums. This value is added to the “basis” referred to previously to determine the value of each individual policy at any given point in time. This value represents a net asset value for each policy similar to the value of a stock or bond at any point in time. Incorporated within the value are the two main components of value to a life settlement transaction which are future premium payments and mortality (life expectancy).

### BACKGROUND OF INVENTION

The classic viatical or life settlement transaction begins with the proposition that a viator owns a life insurance policy on an insured life. In this invention, viatical transaction will be used to describe any assignment of a life insurance policy of an insured with a health condition that impairs the insured's life expectancy (“impaired health”), which assignment is intended to permanently change the ownership of a policy to any investor or other person in return for a sum of money paid by or on behalf of that person. The laws of some states refer to this transaction as a viatical transaction, some as a life settlement, and in some, as a viatical transaction if the life expectancy is under two years, and a life settlement transaction if the life expectancy of the insured is over two years (hereafter all collectively referred to as “life settlement”). An insured with impaired health is intended to include a person who has a shortened life expectancy as a result of illness, but also includes chronic albeit presently no debilitating illness. The policy has a death benefit payable upon death. If there is a loan, that will be netted against the death benefit. Cash surrender value would be a factor in the value of a policy depending on policy terms. The net amount payable on death is referred to as the “net death benefit.” A person, usually with some skill in the area, determines a life expectancy value in years or months for an insured with impaired health and impaired life expectancy. A mortality table or statistical distribution related to that life expectancy value is prepared to accompany that life expectancy value (collectively referred to as a “mortality table” or “impaired health mortality table”). Sometimes the mortality table is referred to as a mortality curve and such a curve is included in the expression “mortality table.” Usually the person preparing the life expectancy value and the mortality table is a life expectancy underwriter with expertise and experience in predicting and preparing the mortality table. Often, a median life expectancy value is given which represents an estimate when 50% of persons with a like health impairment as the insured will have died. Often, a value in years or months is given when 85% of persons with a like health impairment as the insured will have died.

For viators owning a policy on an insured with a life expectancy of between one (or some number of months even less than one year) and fifteen years, the viator wishes to realize present cash in return for an assignment of the policy. An investor offers a lump sum payment and the assumption of the obligation to pay future premiums to the viator in return for the assignment of ownership of the life insurance policy. When the insured dies, assuming the investor kept up the premium payments, the net death benefit is paid to the investor who is the new owner. The risk to the viator is that the insured dies immediately, and the purchase price is substantially exceeded by the death benefit; the risk to the investor is that the insured lives beyond the life expectancy, and the investor has to keep paying premiums to keep the policy in force, and receives the death benefit a number of years past anticipated life expectancy. The investor has lost the present value of the purchase price and received no return for many years with continued advances of cash for premiums.

Previously, third party purchasers of viatical or life settlements had to apply the accounting guidance in FASB (Financial Standards Accounting Board) Technical Bulletin (FTB) No. 85-4, Accounting for Purchases of Life Insurance, to life settlement transactions. FTB 85-4 specifies how an entity should account for the purchase of life insurance and requires the use of the cash surrender value. Because life insurance policies are purchased in the secondary market at amounts in excess of the policies' cash surrender values, the application of the guidance in FTB 85-4 creates a loss upon acquisition of the policy. Adherence to the accounting guidance in Technical Bulletin 85-4 resulted in life settlement providers expensing, on the date of the purchase, the difference between the purchase price of life settlement contracts and their cash surrender value.

Recently, the Financial Accounting Standards Board (“FASB”) has undertaken a project to modify the accounting for life settlements. In their Board Meeting of Nov. 16, 2005, the following decisions were made:

The FASB Board made the following decisions as a result of its Oct. 19, 2005 decision to allow investments in life settlement contracts to be measured either under the investment method or at fair value:

1. An entity's election to measure investments in life settlement contracts at fair value should be an irrevocable item-by-item decision made upon entering into the life settlement contract.

2. At adoption of the proposed FSP, an entity can elect the fair value option for investments in life settlement contracts that are currently held by the entity at the date of adoption.

3. For investments measured at fair value, an entity should:
A. Account for premiums paid in the income statement on the same financial reporting line as the changes in fair value are recognized.
B. Report the cash flows associated with the investments in life settlement contracts under cash flows from investing activities in the statement of cash flows.
C. Apply the following additional disclosure requirements:
   1) Its accounting policy on accounting for investments in life settlement contracts
   2) The method(s) and significant assumptions used to estimate the fair value of investments in life settlement contracts, including any mortality tables used by the entity
   3) The total realized gains or losses for each reporting period presented
   4) The change in unrealized gains or losses during the period for investments that are held at the balance sheet date.

4. For investments measured under the investment method, an entity should disclose the following:
A. Its accounting policy on accounting for investments in life settlement contracts
B. Premiums anticipated to be paid in order to keep the policy in force (instead of maximum premiums per paragraph 8 of the proposed FSP)
C. Five years' worth of such premiums (instead of one year's per paragraph 8 of the proposed FSP).

5. For investments measured under the investment method, an entity should write an impaired investment down to fair value. The Board decided that an entity should test its investments for impairment only when the investor becomes aware of factors that may indicate that an impairment exists. Such indicators would not include a change in interest rates. However, the effect of a change in interest rates would be incorporated into the determination of fair value.

6. The scope exception for certain insurance contracts in paragraph 10(g) of FASB Statement No. 133, Accounting for Derivative Instruments and Hedging Activities, will be expanded to include investments in life settlement contracts.

7. An entity should display on the face of the balance sheet and income statement its investments measured at fair value separately from those measured under the investment method.

8. An entity should apply this guidance prospectively for all new investments and recognize a cumulative effect for all existing investments at the date of adoption as an adjustment of opening retained earnings.

9. This guidance would be effective for fiscal years beginning after Jun. 15, 2006, with early adoption permitted for entities that have not yet issued financial statements for the first quarter.

On Mar. 27, 2006, FASB issued a FASB Staff Position No. 85-4-1 adopting in principle the above listed criteria allowing for the Fair Valuation of Life Settlement Transactions.

The Board decided not to require entities to disclose anticipated future premium payments for investments measured at fair value. In addition, the Board asked the staff to provide it with more information regarding potential disclosure requirements for (a) disclosing an entity's actual versus anticipated mortality and (b) whether an entity should disclose the anticipated average life settlement contract duration.

That net asset value for each policy can be combined for all policies in the fund's pool of policies. To determine the Unit Net Asset Value (Unit NAV) for the fund of individual policies, cash on hand, either from uninvested funds, income or proceeds of matured policies that have not yet been distributed must be added to the combined net asset values of each policy, and then accrued expenses and liabilities must be subtracted.

An additional component of “incremental value” over time may be an appreciation factor (which can be positive or negative) that affects the computed value. This is likely reflected in a percentage multiplier. This appreciation factor may be determined by the market dynamics linked with the life settlement industry as a result of development of the industry, or number of participants in the industry and will most likely increase as efficiency is gained in the purchase of life settlement contracts. It may also be determined by economic forces, such as interest rates or competing financial instruments.

### PRIOR ART

The prior art which exists appears unrelated as would be expected given the recent FASB developments.

Baranowski et al, U.S. Pat. No. 5,926,800, Jul. 20, 1999, entitled “System and method for providing a line of credit secured by an assignment of a life insurance policy” describes itself as an invention that “generally relates to a system for providing loans to owners of life insurance policies who are terminally ill or aged. More specifically, the system comprises a statistical module, medical module and a financial module which together operate on a pre-selected group of inputs to yield a line of credit offered to the policyholder.” Baranowski '800 further describes the invention as “providing a line of credit to those insured under an insurance policy without transfer of ownership of the policy.” Baranowski '800 describes one of the objectives of the invention “to provide a system which both avoids subjective measures of life expectancy and which does not require a doctor's certification.”

The disadvantage of the Baranowski '800 invention is that it limits the amount of up-front cash the owner of the policy, the viator, can receive. The estimate of life expectancy value, and data which is a mortality table (or date form which one can be derived), actually has the advantage of increasing the amount available because otherwise a standard mortality table has to be relied upon. Moreover, the bank or financial services company, referred to in Baranowski '800 as the provider, is in a position to constantly reevaluate its risks and refuse to extend further credit. Thus, the viator, using a Baranowski '800 line of credit bears the risk of extended life beyond a life expectancy, for while the loan is non-recourse, the viator had to take a lower sum based on the standard mortality tables which did not account for the insured's terminal illness, and is now left with an unsaleable policy.

The Baranowski art is of little help in valuing a pool of policies, and in no way integrates mortality tables into the valuation, and does not work well with varying premiums.

Gross et al, U.S. Pat. No. 5,083,270, Jan. 21, 1992, entitled “Method and apparatus for releasing value of an asset” is similar to Baranowski, except that it is not non-recourse. Gross provides for a fund of a large number of participants (he suggests 5,000) and a loan program. The inventors in Gross '270 provide that “As the value of an asset fluctuates, it may be necessary, to the extent that the fluctuations exceed those predicted by the k-value, to require that the participant reduce his promissory obligation or mortgage further assets, or it may be possible to allow him to increase his promissory obligation. The assets preferably are reappraised periodically by the program and the process of the system and method of the invention for dealing with the reappraisal is diagrammed in FIG. 3.”

For someone who is terminally ill, this is an unacceptable risk. Once again, as in Baranowski '800, the viator bears the risk of a life extended beyond the life expectancy, and no transfer of ownership or premium risk is contemplated. The idea of coming up with additional collateral or funds, or the cutoff of a line of credit or available value as the terminally ill person approaches death is psychologically and economically impractical.

Vicente, U.S. Pat. No. 6,393,405, May 21, 2002 claims an arrangement whereby an investor agrees to pay all future level premiums on a policy, and a viator has a continued sharing arrangement that formulaically decreases over time while the portion of death benefit received by an investor rises, the formula being based on a rate of return to the investor.

By contrast to Vicente, the present application proposes that not only does the investor agree to pay all future premiums on a policy, the investor also agrees to pay a substantial sum for the policy.

Vicente's claims address a chronically ill person, which Vicente defines as a person with a life expectancy over 10 years. While Vicente's method is appealing on its face, the reality of the market is that investors are only willing to invest funds where there is no sharing of proceeds for a 10-year plus horizon of life expectancy value. Again, the concept of life expectancy value is where a certain percentage (usually 50%) of deaths of a similarly health impaired person as the insured will have died. In addition, the viator is usually not in a position to meaningfully appreciate what they might receive at some uncertain time in the future with the investor's return driving the transaction. The viator is not interested in the investor's return, nor in merely being relieved of premium cost; the viator wants up-front cash, and no further financial obligation.

If the person does not die at 12 years, the formula in Vicente does not eliminate the risk to the investor; the investor has little choice but to pay the premium, hoping for an eventual death.

Another reality which is not accommodated by the Vicente art is that premiums, even if fixed, vary substantially as a percentage of the death benefit, usually depending on the age and insurance rating (smoker/non-smoker, etc.) of an insured at the time of purchase. The present invention proposes to accommodate any premium and death benefit level, unlike the Vicente invention.

Further, the Vicente art is designed to work with, and the Vicente algorithm only allows for, level premium calculation. In fact, much of the viatical market, as much as 90%, involves so-called “universal life” policies, which are technically “flexible premium, adjustable death benefit” life insurance.

Basically, the prior art is only discussed because it relates to viatical settlements, but none of the prior art discusses or discloses the method proposed in this invention.

### DESCRIPTION OF INVENTION

The present invention would take a different track in valuing the life settlement policies, in a sense beginning at the fair value approach, but then continuing by building substantially more robust analysis on top of the basic approach. The present invention does not conflict with the new standard adopted by FASB from a purely accounting standpoint, and in fact enables a higher level and more sophisticated valuation. Because the methodology satisfies all the requirements of Fair Valuation set forth by FASB, the necessity of an irrevocable election of method of valuation is avoided. One of the most popular methods of valuation is a discounted cash flow model. It has long been an accepted and tested method of discounting future cash flows at a discount rate to determine the present day value. The concern in a life settlement transaction is determining the future cash flow portion of the discounted cash flow model. Several assumptions must be made prior to determining the future cash flows. The basic assumptions would be the anticipated life expectancy, premiums until anticipated life expectancy, and the discount rate. However, to be made more accurate, the basic assumptions referred to would have to be integrated with the estimated mortality and future anticipated premium burden. The accuracy of the assumptions would directly affect the accuracy of the fair value. Because new assumptions could potentially be used each year, the value calculation could vary greatly. Future interest rate changes over time would also impact the discount rate and value, which introduces unwieldy assumptions into a valuation for the present moment. Since a specific rate is not defined in the standards adopted by FASB, it is left to the company to determine the appropriate discount factor. This factor is subjective at best in the absence of defined guidelines. Accordingly the value of a pool of long-term policies would be greatly affected by the discount factor selected. The current fair value according to FASB does not stipulate that future premium burden be disclosed, yet under a discounted cash flow model, they would have to be part of the calculation. There would have to be an assumption made as to how long to fund the policy and since it is up to the company to decide, different mortality curves could be used over time. In the investment approach adopted by FASB, only 5 years of future premium burden needs to be disclosed. The inventors believe this present invention exceeds both FASB approaches in terms of its consistency and disclosure. This present invention funds to 100% mortality (often beyond the five year FASB guideline) and therefore exceeds both the fair value approach and investment approach referenced by FASB in providing disclosure for policies and a net asset value for a pool of policies with a life expectancy of more than 5 years. The main issue is that the future premium burden has a direct impact on the “fair value” of a policy at any given point in time. With policies that have a longer than 5 year life expectancy, under the FASB standard, the investment method does not have to disclose premiums past the 5 year time frame. Since policies have an increasing premium burden over time, this may not and usually will not accurately reflect the future premium burden. Although it must be incorporated into the formula for determining “fair value” increases from year to year, the methodology for application is not specified. In the discounted cash flow model, all the variables in determining the calculation could change from year to year. The present invention would incorporate both the mortality table, as a measure of risk, and future premium burden directly into the calculation of value over time to generate a consistent formula for valuation. There would not be variations from year to year in the assumptions used in the value calculation. The inventors believe this method provides an accurate representation of fair value over time and has a consistent actuarially based approach.

The preferred method of the present invention values a new viatical and life settlement transaction product under the following scenario: The investor pays a substantial sum for the purchase of an insurance policy on the life of an insured from the owner of the policy, who is referred to as the viator. The investor assumes the obligation to pay all future premiums on a policy. The investor will invest in the fund which will purchase all policies and manage the policies to maturity. The policies will be held as the asset as part of a “fund” of policies. The fund construction would be similar to a mutual fund with the policies being the underlying asset.

The present invention proposes to integrate mortality table analysis and the future premium burden thereby creating an NAV to investors holding a unit in the fund. The NAV of an investor's unit would consist of the sum of the net asset value for each policy held by the fund, plus cash on hand, either from uninvested funds, income or proceeds of matured policies that has not yet been distributed less accrued expenses and liabilities, all of which would be divided by the number of outstanding investor units. A major component of NAV in a life settlement transaction is the amount of expected premium burden yet to be paid during the anticipated lifetime of the insured. The future premium burden is in essence the “measure of risk” associated with the policy. As time passes, the predictability of paying future premiums is related to the cumulative mortality curve to a point in time. By determining the remaining cumulative mortality curve, the probability of having to pay the future premiums is ascertained. Incorporating these two elements into the valuation model, the anticipated “incremental value” at any point in time can be calculated.

Additionally, based on that point of time at which the anticipated “incremental value” is determined, the invention enables the determination of whether the burden of premium financing has become excessive compared with the investor or investment pool of policies internally paying for the policies. The invention determines the optimal point in time to remove premium financing or to dispose of the policy to maximize return to the investment pool. The inventors believe this optimization is unique in life settlement transaction arenas and only possible given the fixed nature of the calculations contained within the present invention.

An additional component of “incremental value” over time may be an appreciation factor (which may be positive or negative) that affects the computed value. This appreciation factor may be determined by the market dynamics linked with the life settlement industry and will most likely increase as efficiency is gained in the purchase of life settlement contracts. It may also be determined by economic forces, such as interest rates or returns available from competing financial instruments.

Policy maturity is defined as death or a point where the mortality table shows a 100% probability of death. If a probability distribution is being used as later described, then policy maturity would be the point where the cumulative distribution function shows that cumulative probability of death is a virtual certainty, usually over 99%.

An example of the calculations with associated assumptions is as follows:

The present invention enables accounting for the delay from the time a life expectancy is determined to the time of settlement and purchase of a policy by an investor. The table below is for an insured whose life expectancy at Sep. 1, 2005 was 43 months. An adjustment is made to the life expectancy to correspond to the transaction settlement date of Jan. 1, 2006 to reflect the passage of time so that at Jan. 1, 2006 there are 39 months remaining. Each mortality table is individually medically underwritten for each insured covered by a policy and the associated Life Expectancy (“LE”) as of Jan. 1, 2006 is 39 months at the 50% Mortality Rate as set out in the mortality table below:

TABLE 1

| Years | Lives | Deaths | Accum Deaths |
|---|---|---|---|
| 1 | 917 | 83.00 | 83.00 |
| 2 | 810 | 107.00 | 190.00 |
| 3 | 684 | 126.00 | 316.00 |
| 4 | 553 | 131.00 | 447.00 |
| 5 | 426 | 127.00 | 574.00 |
| 6 | 310 | 116.00 | 690.00 |
| 7 | 214 | 96.00 | 786.00 |
| 8 | 137 | 77.00 | 863.00 |
| 9 | 82 | 55.00 | 918.00 |
| 10 | 44 | 38.00 | 956.00 |
| 11 | 20 | 24.00 | 980.00 |
| 12 | 8 | 12.00 | 992.00 |
| 13 | 3 | 5.00 | 997.00 |
| 14 | 1 | 2.00 | 999.00 |
| 15 | 0 | 1.00 | 1,000.00 |
| 16 | 0 | 0.00 | 1,000.00 |
| 17 | 0 | 0.00 | 1,000.00 |
| 18 | 0 | 0.00 | 1,000.00 |
| 19 | 0 | 0.00 | 1,000.00 |
| 20 | 0 | 0.00 | 1,000.00 |
| 21 | 0 | 0.00 | 1,000.00 |
| 22 | 0 | 0.00 | 1,000.00 |
| 23 | 0 | 0.00 | 1,000.00 |
| 24 | 0 | 0.00 | 1,000.00 |

The above mortality curve is obtained from an independent life expectancy firm specializing in supplying the mortality curve based on the individual medical history of the insured(s) covered by the individual policy. An analysis of the insured(s) conditions indicate an average life expectancy based on the historical statistical information resulting in an actuarially based mortality curve. This present invention uses the cumulative mortality information to determine the expected maturities to occur on an annual basis. From this annual basis curve, interpolation is then used to estimate the number of maturities at any given month along the curve. For example, 107 maturities occurred between the end of year one and the end of year two. This would interpolate to approximately 9 maturities per month in year two.

Another important part of the invention is the estimated cumulative premium to take the policy to 100% Maturity—in this case $268,541—based on a premium illustration obtained from the underwriting carrier prior to purchase. Timing and amount is important. The premium payments are assumed for this example to be made quarterly at the beginning of each quarter. The actual timing would be ascertained for a particular policy. The policy shown has a $500,000 net death benefit.

TABLE 2

| | | | D | E |
|---|---|---|---|---|
| | | C | Probability | NAV |
| | B | Remaining Premium | of Paying | Capped at 85% |
| | Cumulative | ($268,541 | Future | of NDB |
| A | Mortality | Cumulative | Premiums | E = |
| Year | % of Maturities | Premium Paid) | D = (1 − B) * C | Basis + B*(NDB − D) |
| 1 | 8.3% | 268,541 | 246,252 | 171,061 |
| 2 | 19.0% | 257,159 | 208,299 | 205,423 |
| 3 | 31.6% | 250,946 | 171,647 | 253,760 |
| 4 | 44.7% | 240,003 | 132,722 | 314,173 |
| 5 | 57.4% | 225,178 | 95,926 | 381,939 |
| 6 | 69.0% | 206,588 | 64,042 | 425,000 |
| 7 | 78.6% | 184,000 | 39,376 | 425,000 |
| 8 | 86.3% | 161,000 | 22,057 | 425,000 |
| 9 | 91.8% | 138,000 | 11,316 | 425,000 |
| 10 | 95.6% | 115,000 | 5,060 | 425,000 |
| 11 | 98.0% | 92,000 | 1,840 | 425,000 |
| 12 | 99.2% | 69,000 | 552 | 425,000 |
| 13 | 99.7% | 46,000 | 138 | 425,000 |
| 14 | 99.9% | 23,000 | 23 | 425,000 |
| 15 | 100.0% | — | — | 425,000 |

Column B is from the “Deaths” column of Table 1
Basis $150,000
NDB—Net Death Benefit $500,000

The inventors have introduced the assumption in their preferred mode that the value of the policy is at most 85% of Net Death Benefit or $425,000 since from a practical market perspective that seems to be the maximum attainable price for any policy no matter how far past LE. This assumption could be changed or eliminated. Other reasonable assumptions would be 80% or 90% of Net Death Benefit. In this example, the capped value occurs by the end of year 6 (72 months) which is 33 months past LE (39 Months). This net asset value for the policy represents the then current fair value at the end of each year up to the maximum of $425,000.

As another example, which will enable an example of a pool of two policies: The table below is for an insured whose life expectancy at Dec. 12, 2005 was 76 months. An adjustment is made to the life expectancy to correspond to the transaction settlement date of Jan. 1, 2006 to reflect the passage of time so that at Jan. 1, 2006 there are 75 months remaining. Each mortality table is individually medically underwritten and the associated Life Expectancy as of Jan. 1, 2006 is 75 months at the 50% Mortality Rate as set out in the mortality table below:

TABLE 3

| Years | Lives | Deaths | Accum Deaths |
|---|---|---|---|
| 1 | 956 | 44 | 44 |
| 2 | 893 | 63 | 107 |
| 3 | 828 | 65 | 172 |
| 4 | 757 | 71 | 243 |
| 5 | 669 | 88 | 331 |
| 6 | 549 | 120 | 451 |
| 7 | 419 | 130 | 581 |
| 8 | 295 | 124 | 705 |
| 9 | 191 | 104 | 809 |
| 10 | 110 | 81 | 890 |
| 11 | 52 | 58 | 948 |
| 12 | 21 | 31 | 979 |
| 13 | 6 | 15 | 994 |
| 14 | 1 | 5 | 999 |
| 15 | 0 | 1 | 1000 |
| 16 | 0 | 0 | 1000 |
| 17 | 0 | 0 | 1000 |
| 18 | 0 | 0 | 1000 |
| 19 | 0 | 0 | 1000 |
| 20 | 0 | 0 | 1000 |
| 21 | 0 | 0 | 1000 |
| 22 | 0 | 0 | 1000 |
| 23 | 0 | 0 | 1000 |
| 24 | 0 | 0 | 1000 |

Again, an analysis of the insured(s) conditions by an independent life expectancy firm indicates an average life expectancy based on the historical statistical information resulting in an actuarially based mortality curve. This present invention uses the cumulative mortality information to determine the expected maturities to occur on an annual basis. From this annual basis curve, interpolation is then used to estimate the number of maturities at any given month along the curve. For example, 63 maturities occurred between the end of year one and the end of year two. This would interpolate to approximately 5 maturities per month in year two.

Another important part of the invention is the estimate cumulative premium to take the policy to 100% policy maturity—$3,184,352, based on a premium illustration obtained from the underwriting carrier prior to purchase. The premium payments are assumed to be made quarterly at the beginning of each quarter. It should be noted that funding to 100% mortality usually requires an estimated premium that exceeds the Net Death Benefit of the policy. When added to the original investment, the investors would actually encounter a loss by the end of the 8th year of premium payments. Because of the methodology used in this present invention, the policy would be closely monitored to ensure that the investor does not incur a loss. The valuation model allows for the calculations to be done at the time of purchase in order to evaluate the risks to the investor.

The term “stream of premium payments” means the stream of estimated premiums to maintain a policy in force through policy maturity, which is normally either a fixed stream by contract or an estimated stream ascertained from an insurance company premium illustration

TABLE 4

| | | | D | E |
|---|---|---|---|---|
| | | C | Probability | NAV |
| | B | Remaining Premium | of Paying | Capped at 85% |
| | Cumulative | ($3,184,352 - | Future | of NDB |
| A | Mortality | Cumul. | Premiums | E = |
| Year | % of Maturities | Premium Paid) | D = (1 − B) * C | Basis + B*(NDB − D) |
| 1 | 4.4% | 3,184,352 | 3,044,214 | 938,053 |
| 2 | 10.7% | 2,962,508 | 2,645,520 | 977,929 |
| 3 | 17.2% | 2,640,664 | 2,186,470 | 1,079,927 |
| 4 | 24.3% | 2,318,820 | 1,755,347 | 1,242,451 |
| 5 | 33.1% | 1,996,976 | 1,335,977 | 1,490,792 |
| 6 | 45.1% | 1,675,132 | 919,547 | 1,878,239 |
| 7 | 58.1% | 1,353,288 | 567,028 | 2,353,557 |
| 8 | 70.5% | 1,061,046 | 313,009 | 2,550,000 |
| 9 | 80.9% | 819,521 | 156,529 | 2,550,000 |
| 10 | 89.0% | 714,638 | 78,610 | 2,550,000 |
| 11 | 94.8% | 611,293 | 31,787 | 2,550,000 |
| 12 | 97.9% | 506,405 | 10,635 | 2,550,000 |
| 13 | 99.4% | 405,931 | 2,436 | 2,550,000 |
| 14 | 99.9% | 295,159 | 295 | 2,550,000 |
| 15 | 100.0% | 153,614 | — | 2,550,000 |

Basis $940,000
NDB—Net Death Benefit $3,000,000

The assumption again in Table 4 is that the value of the policy is at most 85% of Net Death Benefit or $2,550,000. In this example, the capped value occurs by the end of year 8 (96 months) which is 21 months past LE (75 Months). This policy net asset value represents the then current fair value of the policy at the end of each year up to the maximum of $2,550,000.

The calculations can also be done on a monthly basis if a more detailed mortality table is obtained, or by interpolating between annual figures the mortality for a particular period. The inventors evaluated the performance of interpolation by reviewing several mathematical models to determine the best mode of interpolation. Since the mortality curve is already an actuarial curve, utilizing a least squared fit or exponential curve fit does not appear to enhance the results derived from straight line interpolation. Since there are an estimated defined number of maturities each year, interpolating the difference between mortalities from the end of year versus beginning of year yielded the most accurate method of interpolation. Straight line interpolation is the preferred mode used in this present invention to estimate the values to a point in time, but a least squared fit, exponential curve, or interpolation of the slope of the curve at two annual points to intermediate months are alternative modes of invention.

Although the above illustrations demonstrate valuation at the end of any given year, a monthly valuation can occur by interpolation thereby giving a more frequent valuation. This allows a single policy or in combination, a group of policies to be valued at a “point in time” basis.

The value in this example does not include any market appreciation factor which would accelerate or decelerate the value to the maximum of 85% of Net Death Benefit. The premium financing impact has not been inserted in this example due to the fact that the new buyer would not consider what has already occurred or any financing costs for premiums paid. The new buyer would only be concerned with future premium burden and life expectancy and the new buyer's recalculated return.

Since each policy is valued using its own mortality curve and funding estimated to 100% mortality, the “incremental value curve” that is generated is different based on the conditions of the individual policy. This is much different from applying a single mortality curve to a group of policies or averaging the mortality curves. The inventors believe this is the most accurate method of valuation since no two policies are identical and all possible premiums and mortality are considered.

It is important to note that as a policy approaches life expectancy, to determine an actual fair value it will be necessary to obtain a “fresh” life expectancy valuation. This will in turn generate a new mortality curve that can be expected to generate a “shift” in the net asset value numbers for that policy, either higher or lower.

The attached graph illustrates the valuation methodology for the first example reflected in Tables 1 and 2. The ascending curve that has a straight line component represents the net asset value of the policy with the smooth line curve illustrating the mortality value curve only. The net asset value for the given policy has been capped at 85% of Net Death Benefit as previously discussed. The mortality value curve represents the probability of collecting the value of the net death benefit compared to the initial cost of the policy. It does not take into account future premium burden, only the probability of maturity.

For a fund holding these two policies, looking at the data from Year 4, the net asset value of the policy from the first example would be $314,173 (line for year 4 from Table 2). The net asset value of the policy from the second example would be $1,242,451 (line for year 4 from Table 4). Adding these together, the total would be $1,556,624. If the fund had 70 units outstanding, $100,000 in uninvested investor proceeds, and $150,000 in accrued expenses and liabilities, the Unit NAV would be $21,523.20. Assuming the same uninvested investor proceeds and accrued expenses and liabilities for year 5, the Unit NAV for 70 units would be the sum of $381,939 plus 1,490, 792 plus $100,000 less $150,000 divided by 70 for a Unit NAV of $26,039.01. The more complex and realistic scenario is where investors, attracted by the appreciation, inject funds in year four at the Unit NAV price, and policies are acquired and the methodology of the invention applied with respect to those acquired policies, and then a Unit NAV for year 5 is determined. A person reasonably skilled in the art of accounting can apply the calculations and determine the Unit NAV according to the principles illustrated in the examples. Suppose four investors joined the pool at the Unit NAV price at year 4 at the Unit NAV price of $21,523.20, and assume level expenses, no maturities, no other income and no other policies were acquired, and the same $150,000 accrued liabilities and expenses with payment of the old expenses from the funds taken in.

The calculation at Year 5 would be the sum of $381,939 plus 1,490,792 plus $100,000 plus the $86,092.80 less $150,000 less the second $150,000 divided by 74 for a Unit NAV of $23,767.89. The Unit NAV would still increase over the year.

An additional consideration for formulaic review is the comparison of the straight mortality curve value calculation as denoted in the graph above by the curved dotted black line. This representative curve does not take premium into consideration. The formula is very similar in every other respect. The formula to calculate the straight mortality curve is the basis (as previously described) added with the result of the cumulative mortality times the difference between net death benefit and the basis cost. To illustrate the calculation using the figures from the first year of Table 4, the formula would be $940,000+((4.4%*(3,000,000−940,000)) which would equal $1,030,640. This method disregards any premium calculations and will yield as estimate curve that is much smoother in form due to the lack of premium burden. This method is not the preferred method because of the lack of incorporating the projected premium burden.

If premium burden is desired to be woven into the analysis, the method of doing so would be to compare the final policy value computed with the future premium debt, or amount of premium financing due. If the final policy value was lower than the future premium debt from internal financing, the decision might best be made to sell the policy. If premium financed by an outside source, the decision would be to measure the future cost of the financing against the value of the policy, looking at the maximum value and perhaps the death benefit, and determining if the policy should be sold.

In summary, this present invention incorporates multiple aspects of both valuation methodologies adopted by FASB and then adds layers of analysis to them which the inventors believe more accurately represents a policy's value over time and enable management of a viatical and life settlement fund. By using the individual policy mortality curve and estimating funding to 100% mortality, variance in pricing methodology is eliminated across policies. This provides for a consistent actuarially based approach on all valuations whether a single policy or pool of policies.

Another mode of use of the invention would be to treat a policy several years old as a new purchase. This would call for a new basis of valuation. A new basis of valuation means an appraisal by an independent third party appraiser for a date after the initial date of purchase of a policy, or utilizing a bona fide offer by a third party. Either the new appraisal or the bona fide offer could be used as the deemed purchase price of the policy and the method of this invention then applied to value a policy, group of policies and ultimately a unit holder's net asset value.

Further, mortality tables set out a mean time of death for a person of a particular age. Each of those means for a particular age has an associated variance. Typically, a median life expectancy is specified at which 50% of the deaths for a certain health impairment will have occurred. Secondly, an 85% number is typically specified at which 85% of the deaths for a certain health impairment will have occurred.

Utilizing for instance a Poisson statistical distribution, and knowing the year in which the 50% and 85% numbers occur, meaning when 50% and 85%, respectively of the 1000 life pool will have died, a mortality table can be determined akin to Table 3. This is not the preferred mode, but is functional. Based on that Poisson-determined distribution for the health-impaired individual, or another method of statistical distribution that has an initial level and distribution approaching an asymptote, the remainder of the invention as described can be practiced using this more arbitrarily determined table.

Similarly, a normal statistical distribution can be determined knowing the year in which the 50% and 85% numbers occur, meaning when 50% and 85%, respectively of the 1000 life pool will have died, a mortality table can be determined akin to that set forth in Table 1. This is not the preferred mode, but is functional. Based on that normally distributed determination of distribution deaths for the health-impaired individual, or another method of statistical distribution that has cumulative distribution function approaching one, and has an initially lower level, the remainder of the invention as described can be practiced using this more arbitrarily determined table.

One could also—if only the life expectancy were known, simply assume that the mean was the life expectancy. Since all insureds die, one can assume that at a certain age there would be a death and set that age at four, or alternatively, three, standard deviations and use that assumed standard deviation to determine the parameters of the probability distribution function and cumulative distribution function for a morality curve and mortality table for a given distribution.

Another mode of invention that can be used to develop a net asset value is to adjust each policy asset value as follows: When a policy was purchased, there would have been an interest rate applicable to a zero coupon bond for a term equal to the life expectancy of the insured with respect to the policy. For instance, for a policy with a life expectancy of an insured of ten years, one could find an original interest rate applicable to a zero coupon bond for ten years. If, two years after purchase of the policy, one examines the rate for a zero coupon bond for ten years, the interest rate is likely to be different. The reciprocal of the ratio of the later interest rate times the original interest rate can be multiplied by the policy value calculated under this invention to compute an interest-rate adjusted policy value, again subject to the maximum percentage value criterion set out before.

In addition, as another mode a ten year zero coupon bond is worth more at seven years from maturity of the bond than at the original ten years from the maturity of the bond. The ratio of the value of a ten-year-to-maturity bond to the value of a seven-year-to-maturity bond also results in a term/interest rate adjusted policy value, which would again be subject to the maximum percentage value criterion set out before.

Premium financing can be integrated into the invention. That financing can be either internally financed by reserving funds adequate to pay premiums. Alternatively, externally financing can be used, with any prospective debt due deducted from the value of the policy determined under this invention.

The structural implementation of the invention is on a general purpose computer. There needs to be connection to an input device, either another computer or a keyboard, to a computer, and a connection of a computer to a display device, which is normally a computer monitor, but could be another computer. The connections made can be made by wire, or by programming operating through the internal circuitry of the computer. At least part of the input is normally derived from a paper having data on an insurance policy, and/or the policy itself, and the output ultimately has to be in readable form, and usually a paper copy generated, for offering the fund of life settlements as a security, and for investors to see the results of their investment.

Thus, in determining a unit net asset value price for a fund of life settlements, the fund has normally a series of policies purchased for a policy purchase price, and the policies are usually bought from a settlor on the life of an insured.

First, the computer must be accessible to by wire, or have input from an input unit to the computer, a database containing input of the amount of death benefit payable upon the death of each insured for the policies in the fund.

The computer must be accessible to by wire, or have input from an input unit to the computer, a database containing input of a mortality table for each insured from which the probability of death in a period for each insured can be ascertained.

The computer must be accessible to by wire, or have input from an input unit to the computer, a database containing input of the amount of the stream of premium payments to maintain the policy through policy maturity.

The computer would be programmed to determine on the computer a remaining-premium-payments-through-policy-maturity for each period through policy period. That amount includes the premium payment payable for a given period for which a policy asset value is being ascertained.

The computer must be accessible to by wire, or have input for each policy for which said insured is alive a maximum projected value percentage and be programmed to calculate, using that percentage a maximum policy value for each said at least one policy. Usually the selected maximum percentage is 85%, but it could be 90% or 80%.

The computer must be wired or programmed to use its internal circuitry to determine on the computer a policy asset value for the end of a given period by calculating on said computer an increase in each said at least one policy from the policy purchase price for each policy, with the program and/or wiring to accomplish the following:

a) from the mortality table, the probability of death in a given period;
b) subtraction of that probability of death from 1 on the computer to determine a resultant probability number;
c) multiply that resultant probability number by the earlier referenced remaining-premium-payments-through-policy-maturity for the given period to yield a mortality-table-probability-adjusted-remaining-premium-payable-through-policy-maturity;
d) subtract on that computer the just-generated mortality-table-probability-adjusted-remaining-premium-payable-through-policy-maturity from the remaining-premium-payments-through-policy-maturity which yields a period incremental value increase for the policy during the period being examined for the one policy.

By adding that latter incremental value increase to the period incremental value increase calculated for any preceding periods (there are no preceding periods if the evaluation is for the first period), one obtains a policy asset value.

As stated previously, there is a practical maximum to a policy value of between 80 and 90 percent. That is, even if one knew one was going to die tomorrow, one would not pay the full value of the policy. This effect is even truer because in the United States, the viator or settlor has 15 days to rescind any sale of a policy.

Therefore, the policy asset value calculated is compared to the maximum policy value for each life settlement in the fund and the lesser of the policy asset value or the maximum policy value is used as the “final policy asset value” for each policy.

By adding all the policy values, and dividing by the number of units of ownership, one can determine the unit net asset value for each unit of ownership in said fund. This would have to be generated on a computer monitor or another computer to generate visually perceptible output of the value, and preferably any of the inputs and any final and intermediate results of the calculations on the computer resulting in the unit net asset value. For instance, the remaining life expectancies and the face amount of the policies would be important for investors to know.

The embodiments represented herein are only a few of the many embodiments and modifications that a practitioner reasonably skilled in the art could make or use. The invention is not limited to these embodiments. Alternative embodiments and modifications which would still be encompassed by the invention may be made by those skilled in the art, particularly in light of the foregoing teachings. Therefore, the following claims are intended to cover any alternative embodiments, modifications or equivalents which may be included within the spirit and scope of the invention as claimed.

1. A computer-implemented method of determining a unit net asset value for a fund containing at least one life insurance policy on a general purpose computer, which fund has at least one unit of ownership, and which fund has purchased at least one life settlement for a policy purchase price, including a purchase of a policy from a settlor on the life of an insured, said method comprising the steps of:
enabling access to data concerning the amount of death benefit payable upon the death of each said insured with respect to each said at least one policy of each said settlor in said fund;
enabling access to a mortality table for each said insured from which the probability of death in a period for each said insured can be ascertained;
enabling access to the stream of premium payments to maintain each said at least one policy through policy maturity and from that stream of premium payments determining a remaining-premium-payments-through-policy-maturity for each period through policy period, said remaining-premium-payments-through-policy-maturity including the premium payment payable for a given period for which a policy asset value is being ascertained;
for each said at least one policy for which said insured is alive, selecting a maximum projected value percentage and applying said percentage to said death benefit for each said at least one policy to yield a maximum policy value for each said at least one policy;
for each said at least one policy for which said insured is alive, determining a policy asset value for the end of a given period by calculating an increase in each said at least one policy from said policy purchase price for each said at least one policy, said calculating being:
a) selecting from said mortality table the probability of death in said given period;
b) subtracting said probability of death from 1 to determine a resultant probability number;
c) multiplying said resultant probability number by said remaining-premium-payments-through-policy-maturity for the given period to yield a mortality-table-probability-adjusted-remaining-premium-payable-through-policy-maturity;
d) subtracting said mortality-table-probability-adjusted-remaining-premium-payable-through-policy-maturity from said remaining-premium-payments-through-policy-maturity to yield a period incremental value increase;
adding said period incremental value increase to any period incremental value increase calculated for any preceding periods;
adding said amount to said policy purchase price to determine a policy asset value;
comparing said policy asset value to said maximum policy value for each said at least one said policy and selecting the lesser of said policy asset value or said maximum policy value as the final policy asset value for each said at least one policy;
adding all of said final policy asset values for all policies and adding any other assets held in said fund, less any liabilities of said fund, and dividing by the number of units of ownership is said fund to determine a unit net asset value for each unit of ownership in said fund; and integrating a means for data display connected with said computer to output said unit asset value and to enable generation of visually perceptible output of any of said input and any of the results of said computer resulting in said unit net asset value.

2. The method according to claim 1, further comprising:
said period for each of which periods a probability of mortality shall be determined being one year.

3. The method according to claim 1, further comprising:
said period for each of which periods a probability of mortality shall be determined being one month.

4. The method according to claim 1, further comprising:
said mortality table being an initial mortality table, utilizing for said mortality table a detailed mortality table of periods shorter than the periods set forth in said initial mortality table, said detailed mortality table being produced by interpolating the data for shorter periods from said initial mortality table.

5. The method according to claim 4, further comprising:
said mortality table being an initial mortality table, utilizing for said mortality table a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

6. The method according to claim 4, further comprising:
Said mortality table being an initial mortality table, utilizing for said mortality table a detailed mortality table of periods shorter than the periods set forth in said initial mortality table, said detailed mortality table being produced by interpolating values on a line developed assuming an exponential distribution during the period for which said detailed mortality table of periods shorter than the periods set forth in said initial mortality table is being developed.

7. The method according to claim 1, further comprising:
obtaining a new mortality table for at least one of said at least one policies and re-calculating said net asset value based on said new mortality table.

8. The method according to claim 1, further comprising:
enabling access to a new stream of premium payments to maintain at least one of said at least one policies through policy maturity; and
re-calculating said net asset value based on said new stream of premium payments for said at least one said at least one policies.

9. The method according to claim 8, further comprising:
said period for each of which periods a probability of mortality shall be determined being one year.

10. The method according to claim 8, further comprising:
said period for each of which periods a probability of mortality shall be determined being one month.

11. The method according to claim 8, further comprising:
said mortality table being an initial mortality table, utilizing for said mortality table a detailed mortality table of periods shorter than the periods set forth in said initial mortality table, said detailed mortality table being produced by interpolating the data for shorter periods from said initial mortality table.

12. The method according to claim 11, further comprising:
said mortality table being an initial mortality table, utilizing for said mortality table a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

13. The method according to claim 11, further comprising:
Said mortality table being an initial mortality table, utilizing for said mortality table a detailed mortality table of periods shorter than the periods set forth in said initial mortality table, said detailed mortality table being produced by interpolating values on a line developed assuming an exponential distribution during the period for which said detailed mortality table of periods shorter than the periods set forth in said initial mortality table is being developed.

14. The method according to claim 1, further comprising:
enabling access to any cash surrender value and any outstanding policy loan for each said at least one life insurance policy; and
utilizing a net death benefit payable as said death benefit for each said at least one policy.

15. The method according to claim 14, further comprising:
said period for each of which periods a probability of mortality shall be determined being one year.

16. The method according to claim 14, further comprising:
said period for each of which periods a probability of mortality shall be determined being one month.

17. The method according to claim 14, further comprising:
said mortality table being an initial mortality table, utilizing for said mortality table a detailed mortality table of periods shorter than the periods set forth in said initial mortality table, said detailed mortality table being produced by interpolating the data for shorter periods from said initial mortality table.

18. The method according to claim 17, further comprising:
said mortality table being an initial mortality table, utilizing for said mortality table a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

19. The method according to claim 17, further comprising:
Said mortality table being an initial mortality table, utilizing for said mortality table a detailed mortality table of periods shorter than the periods set forth in said initial mortality table, said detailed mortality table being produced by interpolating values on a line developed assuming an exponential distribution during the period for which said detailed mortality table of periods shorter than the periods set forth in said initial mortality table is being developed.

20. The method according to claim 14, further comprising:
obtaining a new mortality table for at least one of said at least one policies and re-calculating said net asset value based on said new mortality table.

21. The method according to claim 14, further comprising:
enabling access to a new stream of premium payments to maintain at least one of said at least one policies through policy maturity; and
re-calculating said net asset value based on said new stream of premium payments for said at least one said at least one policies.

22. The method according to claim 21, further comprising:
said period for each of which periods a probability of mortality shall be determined being one year.

23. The method according to claim 21, further comprising:
said period for each of which periods a probability of mortality shall be determined being one month.

24. The method according to claim 21, further comprising:
said mortality table being an initial mortality table, utilizing for said mortality table a detailed mortality table of periods shorter than the periods set forth in said initial mortality table, said detailed mortality table being produced by interpolating the data for shorter periods from said initial mortality table.

25. The method according to claim 24, further comprising:
said mortality table being an initial mortality table, utilizing for said mortality table a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

26. The method according to claim 24, further comprising:
Said mortality table being an initial mortality table, utilizing for said mortality table a detailed mortality table of periods shorter than the periods set forth in said initial mortality table, said detailed mortality table being produced by interpolating values on a line developed assuming an exponential distribution during the period for which said detailed mortality table of periods shorter than the periods set forth in said initial mortality table is being developed.

27. The method according to claim 14, further comprising:
obtaining a new basis of valuation for at least one of said at least one policies and re-calculating said net asset value using said new basis of valuation as said purchase price for said at least one of said at least one policies.

28. The method according to claim 27, further comprising:
obtaining a new mortality table for at least one of said at least one policies and re-calculating said net asset value based on said new mortality table.

29. The method according to claim 1, further comprising:
adjusting policy asset value by determining the ratio for current prevailing interest rate for a specified period approximately equal to an original life expectancy under said mortality table for a specific security at the time of purchase of said life settlement by said fund divided by the prevailing interest rate for said same specified period of said original life expectancy for a similar specific security as of the date of determination of said value of said life insurance policy and multiplying said ratio by said policy asset value.

30. The method according to claim 1, further comprising:
adjusting policy asset value by determining the ratio of the prevailing interest rate for a specified type of security whose term is approximately equal to the life expectancy at the time of purchase of said life settlement divided by the prevailing interest rate for the same specified type of security whose term is approximately equal to the life expectancy at the time of valuation of said policy, and multiplying said ratio times said policy asset value.

31. The method according to claims 1-30, further comprising:
financing said premium payments on at least one policy in said fund of policies in order to decrease the initial cash outlay for the procurement of rights in a policy purchased as a life settlement and maintenance of payment of said premiums; and
offsetting against said final policy value any prospective amount due to be paid for said financing of said premium payments.

32. The method according to claims 1-30, further comprising the following step:
said maximum projected value percentage being 85%.

33. (canceled)

34. (canceled)

35. The method according to claims 1-30, further comprising:
financing said premium payments on at least one policy in said fund of policies in order to decrease the initial cash outlay for the procurement of rights in a policy purchased as a life settlement and maintenance of payment of said premiums;
offsetting against said final policy value any prospective amount due to be paid for said financing of said premium payments; and
said maximum projected value percentage being 85%.

36. (canceled)

37. (canceled)

38. A computer-implemented method of determining a unit net asset value on a general purpose computer for a fund containing at least one life insurance policy, which fund has at least one unit of ownership, and which fund has purchased at least one life settlement for a policy purchase price, including a purchase of a policy from a settlor on the life of an insured, said method comprising:
means for connecting said computer to a database containing input of the amount of death benefit payable upon the death of each said insured with respect to each said at least one policy of each said settlor in said fund;
means for connecting said computer to input of a mortality table for each said insured from which the probability of death in a period for each said insured can be ascertained;
means for connecting said computer to input of the stream of premium payments to maintain each said at least one policy through policy maturity and from that stream of premium payments determining on said computer a remaining-premium-payments-through-policy-maturity for each period through policy period, said remaining-premium-payments-through-policy-maturity including the premium payment payable for a given period for which a policy asset value is being ascertained;
for each said at least one policy for which said insured is alive, means for inputting to said computer and means for connecting to said computer input a maximum projected value percentage and having means for calculating on said computer to apply said percentage to said death benefit for each said at least one policy to calculate a maximum policy value for each said at least one policy;
for each said at least one policy for which said insured is alive, means for determining on said computer a policy asset value for the end of a given period by calculating on said computer an increase in each said at least one policy from said policy purchase price for each said at least one policy, said computer being programmed to:
a) use said means for connecting to said mortality table and said computer to select from said mortality table the probability of death in said given period;
b) subtract said probability of death from 1 on said computer to determine a resultant probability number;
c) multiply on said computer said resultant probability number by said remaining-premium-payments-through-policy-maturity for the given period to yield a mortality-table-probability-adjusted-remaining-premium-payable-through-policy-maturity;
d) subtract on said computer said mortality-table-probability-adjusted-remaining-premium-payable-through-policy-maturity from said remaining-premium-payments-through-policy-maturity to yield a period incremental value increase;
e) and then add on said computer said period incremental value increase to any period incremental value increase calculated for any preceding periods;
f) adding on said computer said amount to said policy purchase price to determine a policy asset value;
g) compare said policy asset value to said maximum policy value for each said at least one said policy and selecting the lesser of said policy asset value or said maximum policy value as the final policy asset value for each said at least one policy;
h) add on said computer all of said final policy asset values for all policies and add any other assets held in said fund, less any liabilities of said fund, and divide by the number of units of ownership is said fund to determine a unit net asset value for each unit of ownership in said fund; and
a means for data display connected with said computer to output said unit asset value and to enable generation of visually perceptible output of any of said input and any of the results of said computer resulting in said unit net asset value.

39. The method according to claim 38, further comprising:
said period for each of which periods a probability of mortality shall be determined being one year.

40. The method according to claim 38, further comprising:
said period for each of which periods a probability of mortality shall be determined being one month.

41. The method according to claim 38, further comprising:
said mortality table being a detailed mortality table of periods shorter than the periods set forth in said mortality table, said detailed mortality table being produced by interpolating the data for shorter periods from said mortality table.

42. The method according to claim 41, further comprising:
said mortality table being an initial mortality table, a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

43. The method according to claim 41, further comprising:
said mortality table being an initial mortality table, a detailed mortality table of periods shorter than the periods set forth in said initial mortality table, said detailed mortality table being produced by utilizing values on a line developed assuming an exponential distribution during the period for which said detailed mortality table of periods shorter than the periods set forth in said initial mortality table is being developed.

44. The method according to claim 38, further comprising:
means for connecting said computer to input of a new mortality table for at least one of said at least one policies; and
on said computer, re-calculating said net asset value based on said new mortality table.

45. The method according to claim 38, further comprising:
means for connecting said computer to input of a new stream of premium payments to maintain at least one of said at least one policies through policy maturity; and
on said computer, re-calculating said net asset value based on said new stream of premium payments for said at least one said at least one policies.

46. The method according to claim 45, further comprising:
said period for each of which periods a probability of mortality shall be determined being one year.

47. The method according to claim 45, further comprising:
said period for each of which periods a probability of mortality shall be determined being one month.

48. The method according to claim 45, further comprising:
said mortality table being a detailed mortality table of periods shorter than the periods set forth in said mortality table, said detailed mortality table being produced by interpolating the data for shorter periods from said mortality table.

49. The method according to claim 48, further comprising:
said mortality table being an initial mortality table, a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

50. The method according to claim 48, further comprising:
said mortality table being an initial mortality table, a detailed mortality table of periods shorter than the periods set forth in said initial mortality table, said detailed mortality table being produced by utilizing values on a line developed assuming an exponential distribution during the period for which said detailed mortality table of periods shorter than the periods set forth in said initial mortality table is being developed.

51. The method according to claim 38, further comprising:
means for connecting said computer to input of any cash surrender value and any outstanding policy loan for each said at least one life insurance policy; and
said computer subtracting said input of cash surrender value for each said at least one life insurance policy from said amount of said death benefit payable on each said at least one life insurance policy to calculate a net death benefit payable as said death benefit for each said at least one policy.

52. The method according to claim 51, further comprising:
said period for each of which periods a probability of mortality shall be determined being one year.

53. The method according to claim 51, further comprising:
said period for each of which periods a probability of mortality shall be determined being one month.

54. The method according to claim 51, further comprising:
said mortality table being a detailed mortality table of periods shorter than the periods set forth in said mortality table, said detailed mortality table being produced by interpolating the data for shorter periods from said mortality table.

55. The method according to claim 54, further comprising:
said mortality table being an initial mortality table, a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

56. The method according to claim 54, further comprising:
said mortality table being an initial mortality table, a detailed mortality table of periods shorter than the periods set forth in said initial mortality table, said detailed mortality table being produced by utilizing values on a line developed assuming an exponential distribution during the period for which said detailed mortality table of periods shorter than the periods set forth in said initial mortality table is being developed.

57. The method according to claim 51, further comprising:
means for connecting said computer to a new mortality table for at least one of said at least one policies; and
said computer re-calculating said net asset value based on said new mortality table

58. The method according to claim 51, further comprising:
means for connecting said computer to a new stream of premium payments to maintain at least one of said at least one policies through policy maturity; and
said computer re-calculating said net asset value based on said new stream of premium payments for said at least one said at least one policies.

59. The method according to claim 58, further comprising:
said period for each of which periods a probability of mortality shall be determined being one year.

60. The method according to claim 58, further comprising:
said period for each of which periods a probability of mortality shall be determined being one month.

61. The method according to claim 58, further comprising:
said mortality table being a detailed mortality table of periods shorter than the periods set forth in said mortality table, said detailed mortality table being produced by interpolating the data for shorter periods from said mortality table.

62. The method according to claim 61, further comprising:
said mortality table being an initial mortality table, a detailed mortality table of periods shorter than the periods set forth in said initial mortality table, said detailed mortality table being produced by interpolating values on a line developed using a least squares estimate for such line based on at least one period other than the period for which said detailed mortality table of periods shorter than the periods set forth in said initial mortality table is being developed.

63. The method according to claim 61, further comprising:
said mortality table being an initial mortality table, a detailed mortality table of periods shorter than the periods set forth in said initial mortality table, said detailed mortality table being produced by utilizing values on a line developed assuming an exponential distribution during the period for which said detailed mortality table of periods shorter than the periods set forth in said initial mortality table is being developed.

64. The method according to claim 51, further comprising:
means for connecting to input of a new basis of valuation for at least one of said at least one policies; and
said computer re-calculating said net asset value using said new basis of valuation as said purchase price for said at least one of said at least one policies.

65. The method according to claim 64, further comprising:
means for connecting to input of a new mortality table for at least one of said at least one policies; and
said computer re-calculating said net asset value based on said new mortality table

66. The method according to claim 38, further comprising:
means for connecting to a first input of a current prevailing interest rate for a specified period approximately equal to an original life expectancy under said mortality table for a specific security at the time of purchase of said life settlement by said fund and
means for connection to a second input of a prevailing interest rate for said same specified period of said original life expectancy for a similar specific security as of the date of determination of said value of said life insurance policy; and
said computer then dividing said first input by said second input and multiplying said ratio by said policy asset value to generate an adjusted policy asset value to use as a policy asset value in said method.

67. The method according to claim 38, further comprising:
means for connecting to a first input of a prevailing interest rate for a specified type of security whose term is approximately equal to the life expectancy at the time of purchase of said life settlement;
means for connecting to a second input of a prevailing interest rate for the same specified type of security whose term is approximately equal to the life expectancy of said insured at the time of valuation of said policy; and
said computer then dividing said first input by said second input and multiplying said ratio times said policy asset value to generate an adjusted policy asset value to use as a policy asset value in said method.

68. The method according to claims 38-67, further comprising:
means for connecting to input of payments for financing said premium payments on at least one policy in said fund of policies in order to decrease the initial cash outlay for the procurement of rights in a policy purchased as a life settlement and maintenance of payment of said premiums;
and from said final policy value, subtracting on said computer any prospective amount due to be paid based on said input of payments for said financing of said premium payments.

69. The method according to claims 38-67, further comprising the following step:
said maximum projected value percentage being 85%.

70. (canceled)

71. (canceled)

72. The method according to claims 38-67, further comprising:
means for connecting to input of payments for financing said premium payments on at least one policy in said fund of policies in order to decrease the initial cash outlay for the procurement of rights in a policy purchased as a life settlement and maintenance of payment of said premiums;
from said final policy value, subtracting on said computer any prospective amount due to be paid based on said input of payments for said financing of said premium payments;
and said maximum projected value percentage being 85%.

73. (canceled)

74. (canceled)
